(19) United States
(12) Patent Application Publication
(10) Pub. No.: US 2017/0259745 A1
(43) Pub. Date: Sep. 14, 2017

(54) MOTOR VEHICLE WITH LUGGAGE COMPARTMENT FLOOR

(71) Applicant: GM GLOBAL TECHNOLOGY OPERATIONS LLC, Detroit, MI (US)

(72) Inventor: Thilo SCHAEFER, Ruesselsheim (DE)

(73) Assignee: GM GLOBAL TECHNOLOGY OPERATIONS LLC, Detroit, MI (US)

(21) Appl. No.: 15/454,960

(22) Filed: Mar. 9, 2017

(30) Foreign Application Priority Data
Mar. 9, 2016 (DE) 102016002886.6

(51) Int. Cl. B60R 5/04; B60R 13/08

(52) U.S. Cl. CPC B60R 5/044; B60R 13/08

(57) ABSTRACT

A motor vehicle includes a body with a luggage compartment for holding cargo and a movable luggage compartment floor providing a lower border for the luggage compartment to support cargo on the luggage compartment floor. The floor includes a loading floor carrier and a cover on the loading floor carrier. An attachment pivotably mounts and holds the luggage compartment floor at a front end region. The cover is formed on a partial elongated section before a front end of the loading floor carrier in the longitudinal direction of the motor vehicle.

### CROSS-REFERENCE TO RELATED APPLICATION

This application claims priority to German Patent Application No. DE 102016002886.6, filed Mar. 9, 2016, which is incorporated herein by reference in its entirety.

### TECHNICAL FIELD

The present disclosure relates to a motor vehicle with a luggage compartment.

### BACKGROUND

Motor vehicles with seats for conveying people typically include a trunk or luggage compartment for conveying cargo inside of the trunk. The trunk is here generally bounded at the front by a rear part of a rear seat in a longitudinal direction of the motor vehicle, and at the back by a tailgate and an interior trim as well as part of the body of the motor vehicle in the longitudinal direction. The side of the trunk is bounded by side panels on the body of the motor vehicle. The bottom of the trunk is bounded by a luggage compartment floor, and the luggage compartment floor is used for placing cargo on an upper side of the luggage compartment floor. The luggage compartment floor encompasses a stiff, plate-like loading floor carrier, and a cover fastened to an upper side of the loading floor carrier, which is generally configured as a carpet floor or felt support. Sound insulation is generally fastened to the bottom side of the loading floor carrier. The luggage compartment floor can be removed and/or pivoted from the remaining motor vehicle, so that a spare wheel located in a spare wheel well under the luggage compartment floor or other objects can be removed. As a result, the luggage compartment floor bridges the spare wheel well.

A stop element serves as a stop at a front end of the luggage compartment floor, so as to block a forward movement by the luggage compartment floor in the longitudinal direction of the motor vehicle. A support element is used to support a front end region of the luggage compartment floor. The front stop and/or support element also serves to pivotably mount the luggage compartment floor. A rear end of the luggage compartment floor is blocked from moving rearward by a rear stop and support element. The rear stop and support element is formed by the body or a separate component, for example an interior trim. The stop and support element for the front end region of the luggage compartment floor is located between the front end of the loading floor carrier and a rear part of a rear seat. In particular with the tailgate or trunk lid open, the stop and support element is visible and leaves a negative visual impression, because the stop and support element is designed differently than the cover of the luggage compartment floor from both a visual and haptic standpoint.

DE 39 34 403 A1 shows a fastener for a luggage compartment floor plate, which exhibits a border wall section, a support section for holding and carrying the floor plate thereon, and a convex section on the support section, which extends outwardly and hooks into a borehole provided in the floor plate for holding the plate in its place, wherein the border wall section is provided with a protruding edge, which serves to control the shifting movement of the floor plate, wherein it is ensured that the floor plate hooked into the convex section cannot be removed from the convex section until such time as the other front portion of the floor plate is lifted.

### SUMMARY

The present disclosure provides a motor vehicle with a luggage compartment in which the luggage compartment floor exhibits the same visual and haptic characteristics from a rear end of the luggage compartment floor up to a rear part of the rear seat.

In particular, a motor vehicle includes a body, at least one drive engine such as a combustion engine and/or an electric motor, a luggage compartment for holding cargo, a movable luggage compartment floor for bounding the luggage compartment from below, and for supporting cargo on the luggage compartment floor with a loading floor carrier and a cover on the loading floor carrier, and an attachment pivotably mounting and retaining the luggage compartment floor on a front end region. The cover is formed on a partial elongated section before a front end of the loading floor carrier in the longitudinal direction of the motor vehicle. The partial elongated section can thus visually cover a region between a rear part of the rear seat and a front end of the loading floor carrier, at least partially. As a result, the bottom side between the rear end of the luggage compartment floor up to the rear part of the rear seat can be identically designed at least partially from a visual and haptic standpoint in the luggage compartment or trunk. Furthermore, the partial elongated section of the cover serves to provide additional sound insulation for the interior space, preferably given the additional formation of sound insulation on a bottom side of the partial elongated section.

In an additional embodiment, no connection is established between the cover and upper side of the loading floor carrier above the attachment, in particular no integral connection. As a consequence, the cover can exhibit a distance from the loading floor carrier above the loading floor carrier and above the attachment, and thereby be optimally adjusted to geometric requirements, for example stemming from the body or attachment.

In an additional embodiment, the expansion of the partial elongated section of the cover in a transverse direction essentially corresponds to the expansion of the loading floor carrier at a front end region. The partial elongated section can thereby border the entire lower end of the luggage compartment at the front end region of the luggage compartment. Thus, that the expansion of the partial elongated section of the cover as viewed in the transverse direction of the motor vehicle corresponds to the expansion of the loading floor carrier in the transverse direction of the motor vehicle at the front end region of the loading floor carrier with a deviation of less than 30%, 20%, 10% or 5%.

In a supplemental embodiment, the expansion of the partial elongated section of the cover in the longitudinal direction of the motor vehicle measures at least 1%, 3%, 5%, 10% or 20% of the total expansion of the loading floor carrier in the longitudinal direction of the motor vehicle. As a consequence, the partial elongated section exhibits a significant expansion in the longitudinal direction of the motor vehicle, and can thereby completely cover this region even given a larger distance between the front end of the loading floor carrier and a rear end of the rear part of the rear seat.

In a supplemental embodiment, a front end of the partial elongated section of the cover rests and/or abuts against a rear seat, in particular a rear part of the rear seat. As a consequence, the partial elongated section of the cover completely covers the region between the front end of the loading floor carrier and the rear seat, in particular the rear part of the rear seat. The front end of the partial elongated section here preferably lies completely on and/or against the rear seat as viewed in the transverse direction of the motor vehicle, in particular the rear part of the rear seat.

In an additional variant, the cover is integrally joined to a partial region of the upper side of the loading floor carrier, in particular with adhesive.

In a supplementary embodiment, the cover is bendable and/or flexible in design, so that the partial elongated section of the cover is also bendable and/or flexible in design. As a consequence, the partial elongated section can be easily and flexibly adapted to varying geometries, for example the body and/or the attachment. This makes it especially easy to insert the partial elongated section into the motor vehicle during assembly.

It is expedient that sound insulation be fastened to a bottom side of the partial elongated section of the cover.

In an additional variant, the sound insulation is integrally joined to a bottom side of the loading floor carrier, in particular with adhesive.

In an additional embodiment, the sound insulation is bendable and/or flexible in design, so that the partial elongated section of the cover is also bendable and/or flexible in design along with the sound insulation. As a consequence, the sound insulation on the bottom side of the partial elongated section can be flexibly and easily adapted to various necessary geometries, just like the cover. The sound insulation on the partial elongated section thereby also enables a sound insulation of the region between the rear seat and front end of the loading floor carrier.

In an additional variant, the attachment encompasses a front stop element for limiting a forwardly directed movement by the luggage compartment floor in the longitudinal direction. The attachment preferably also encompasses several front stop elements and/or at least one front stop element. The at least one front stop element serves as a stop for the front end of the luggage compartment floor, in particular the loading floor carrier. A front end of the loading floor carrier thus preferably rests on the at least one front stop element.

In another embodiment, the attachment encompasses a front support element located below the luggage compartment floor for supporting a front end region of the luggage compartment floor. It is expedient for the attachment to encompass at least one front support element. The at least one front support element absorbs forces directed vertically downward.

In an additional variant, the front stop element and a front end region of the loading floor carrier are geometrically complementary to each other in design, so that forces in the transverse direction of the motor vehicle can be positively transferred from the loading floor carrier to the front stop element. At least one positive geometry, in particular a projection, is formed at the front end region of the loading floor carrier, and at least one complementary geometry, in particular a recess, is formed at the front stop element, so that a positive connection between the positive geometry and the complementary geometry thereby makes it possible to transfer forces in the transverse direction of the motor vehicle from the loading floor carrier to the front stop element. This blocks the luggage compartment floor from laterally shifting or sliding at the front end region of the loading floor carrier. This also holds true when pivoting the luggage compartment floor, i.e., when lifting the rear end of the luggage compartment floor to gain access to a spare wheel well, so that the loading floor carrier is blocked or prevented from transversely shifting at the front end of the loading floor carrier, even with the luggage compartment floor in such a lifted, pivoted position. In a supplemental embodiment, projections are formed at the front end region of the loading floor carrier, which positively engage into recesses at the front stop element or vice versa.

The entire cover is preferably designed as a single piece. In an additional variant, the cover is designed as a carpet, fabric, felt or film.

In a supplemental embodiment, the motor vehicle encompasses a rear stop element for limiting a rearwardly directed movement by the luggage compartment floor in the longitudinal direction. In another variant, the motor vehicle encompasses a rear support element located below the luggage compartment floor for supporting a rear end region of the luggage compartment floor. It is expedient for the rear stop element and/or the rear support element to be formed by an interior trim, in particular a loading edge trim, and/or by the body.

In a supplemental embodiment, the attachment is formed by the interior trim and/or by the body. In another embodiment, the front stop element is slotted in design, preferably with recesses. In another embodiment, the loading floor carrier and/or the cover are formed above the attachment.

In another embodiment, a two-part sound insulation is fastened to a bottom side of the loading floor carrier; preferably, a first part of the sound insulation is fastened to the partial elongated section of the loading floor carrier, and a second portion of the sound insulation is fastened to the remaining loading floor carrier outside of the partial elongated section, and no sound insulation is preferably fastened to the bottom side of the loading floor carrier between the first and second portion of the sound insulation.

In another embodiment, the loading floor carrier is made out of metal and/or wood and/or plastic. It is expedient for the loading floor carrier to be plate-shaped and/or stiff in design.

### BRIEF DESCRIPTION OF DRAWINGS

The present disclosure will hereinafter be described in conjunction with the following drawing figures, wherein like numerals denote like elements.

FIG. 1 is a longitudinal section or side view of a motor vehicle;

FIG. 2 is a longitudinal section of the motor vehicle according to FIG. 1 in the area of a luggage compartment floor;

FIG. 3 is a top view of the loading floor according to FIG. 2; and

FIG. 4 is a top view of a loading floor carrier of the loading floor according to FIG. 2, and a front stop element for the loading floor carrier.

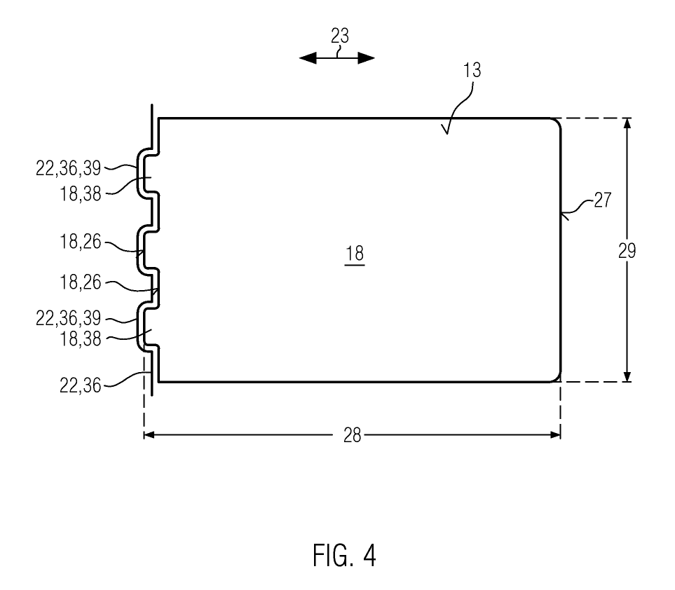

### DETAILED DESCRIPTION

The following detailed description is merely exemplary in nature and is not intended to limit the present disclosure or the application and uses of the present disclosure. Furthermore, there is no intention to be bound by any theory presented in the preceding background of the present disclosure or the following detailed description.

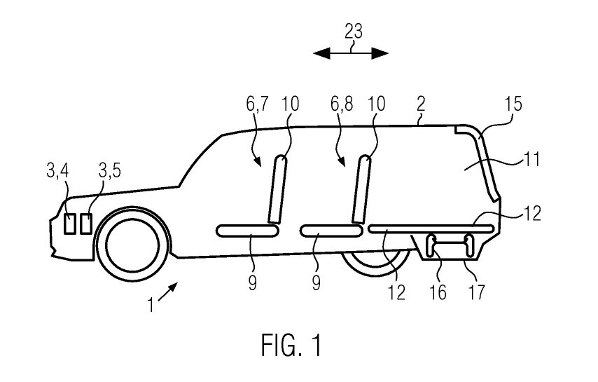

A motor vehicle 1 shown on FIG. 1 exhibits a body 2 made out of steel. A drive engine 3, specifically an electric motor 4 and/or an internal combustion engine 5, drives the motor vehicle 1. The body 2 borders an interior space, within which are located seats 6, specifically front seats 7 and rear seats 8, for accommodating passengers or people. The seats 6 each exhibit a seat part 9 and a rear part 10. Behind the rear seats 8, a trunk 11 is formed between the rear seat 8 and a pivotable tailgate 15. The trunk 11 or luggage compartment 11 is bounded from below by a movable loading room floor 12. A spare wheel well 17 is formed out of the body under the loading room floor 12. A spare wheel 16 and onboard toolbox (not shown) are located inside a receiving space between the loading room floor 12 and the spare wheel well 17. The terms trunk 11 and luggage compartment 11 are regarded as having the same meaning.

The loading room floor 12 serves to support cargo on an upper side of the loading room floor 12. During normal use as a loading room floor 12 for supporting cargo, the loading room floor 12 is essentially horizontally aligned. The upper side is here included of a cover 19 as a carpet 20, and the cover 19 is integrally fastened to an upper side 13 of a stiff, flat and plate-shaped loading floor carrier 18 by an adhesive bond on the loading floor carrier 18.

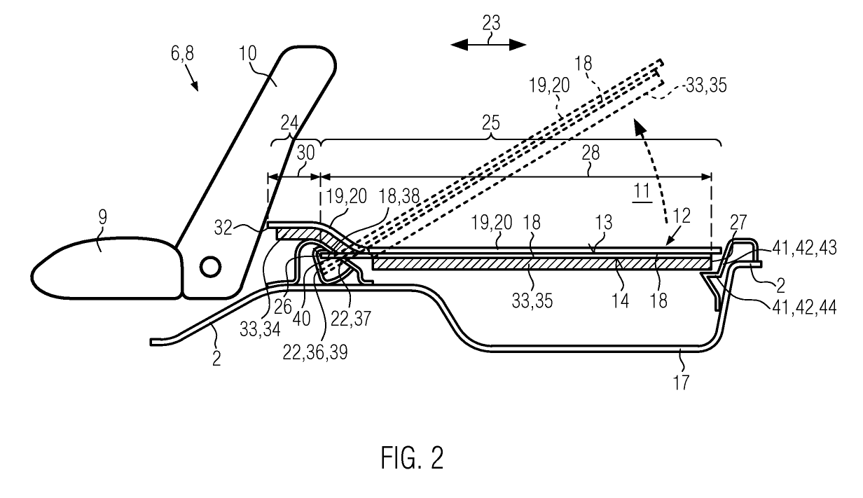

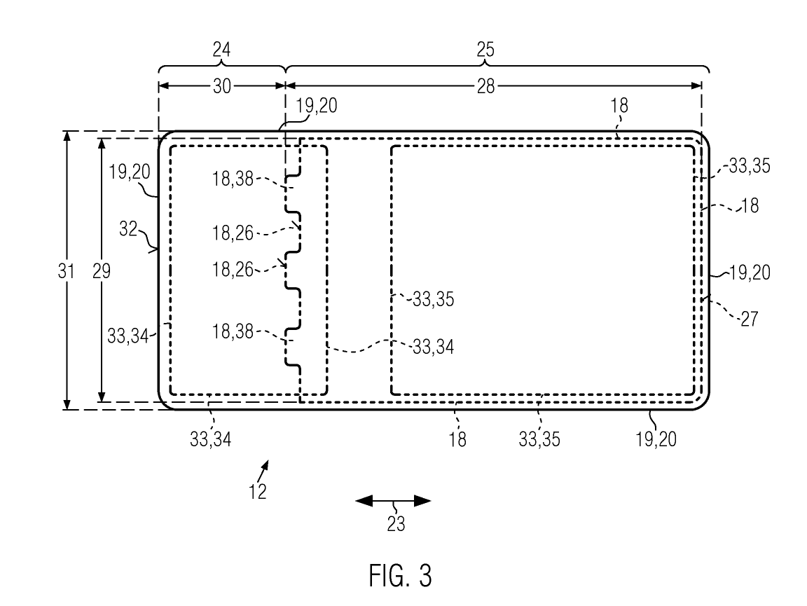

A sound insulation 33 is fastened to a bottom side 14 of the loading floor carrier 18. The sound insulation 33 has two parts, a first part 34 and a second part 35. The cover 19 is divided into an imaginary partial elongated section 24 and an imaginary partial main section 25. The one-part cover 19 is formed in a longitudinal direction 23 of the motor vehicle 1 as the partial elongated section 24 before a front end 26 of the loading floor carrier 18, and the cover 19 is imaginarily fixed as the partial main section 25 outside of the partial elongated section 24. The loading floor carrier 18 also exhibits a rear end 27, and the cover slightly overlaps 19 the rear end 27 of the loading floor carrier 18 in the longitudinal direction 23 (FIGS. 2 and 3).

The stiff loading floor carrier 18 essentially assumes the forces for supporting the cargo on the luggage compartment floor 12. To this end, the front end region of the bottom side 14 of the loading floor carrier 18 rests on a front support element 37 formed in the transverse direction. The motor vehicle 1 further also encompasses a front stop element 36 that expands essentially in the transverse direction of the motor vehicle 1 to limit a movement by the luggage compartment floor 12 directed toward the front in the longitudinal direction. For this purpose, the front end 26 of the loading floor carrier 18 rests on the front stop element 36. The front stop element 36 and the front support element 37 thus include an attachment 22 for holding and pivotably mounting the front end region of the luggage compartment floor 12.

At the rear end region of the luggage compartment floor 12, the loading floor carrier 18 rests on a rear support element 43 to limit a movement by the luggage compartment floor 12 directed toward the back in the longitudinal direction. A rear end region of the bottom side 14 of the loading floor carrier 18 rests on a rear support element 44. The rear stop element 43 and rear support element 44 are here included of an interior trim 41 as a loading edge trim 42 (FIG. 2). Deviating therefrom (not shown), the rear stop element 43 and rear support element 44 can also be formed by the body 2. The rear end region of the luggage compartment floor 12 can be lifted to provide access to the spare tire well 17, so that a front end region of the luggage compartment floor 12 can thereby be pivoted around a swiveling axis in the transverse direction of the motor vehicle, and this swiveling axis is aligned or formed in the area of the front stop element 36, so that the front stop element 36 resultantly also serves as an attachment 22 for mounting the luggage compartment floor 12 so that it can pivot around this swiveling axis.

The front end region of the loading floor carrier 18 is situated inside of a slot 40 formed by the front stop element 36, extending predominantly or essentially in the transverse direction of the motor vehicle 1 (FIG. 2). Recesses 39 are here formed on the slotted front stop element 36, and hence inside of the slot 40, and these recesses 39 incorporate a respective projection 38 at the front end region of the loading floor carrier 18. The projections 38 thus each form a positive geometry and the recesses 39 each form a complementary geometry. The rear end of the loading floor carrier 18 rests on the rear stop element 43, and based on the positive connection between the projections 38 and recesses 39, this makes it possible to transfer transverse forces from the loading floor carrier 18 to the recesses 39, and hence to the front stop element 36. A movement by the luggage compartment floor 12 in the transverse direction is resultantly blocked at the front end region, and also blocked at the rear end region of the loading floor carrier 18 by corresponding rear lateral stop elements (not shown).

In order to remove the spare wheel 16 in the spare wheel well 17, the rear end region of the luggage compartment floor 12 has to be lifted, so that the luggage compartment floor 12 is pivoted around the swiveling axis at the front end region. The front stop element 36 thus also serves as a hinge for pivoting the luggage compartment floor 12 around the swiveling axis in the transverse direction of the motor vehicle 1. The positive connection between the projections 38 and recesses 39 here advantageously blocks a movement in the transverse direction of the front end region of the luggage compartment floor 12 even in this lifted or pivoted position of the luggage compartment floor 12, as denoted on FIG. 2 with dashed lines.

The expansion 31 in the transverse direction of the partial elongated section 24 of the cover 19 essentially corresponds to the expansion 29 of the loading floor carrier 18 in the transverse direction. As a consequence, the partial elongated section 24 of the cover 19 completely covers the area between the side panels (not shown) of the trunk 11, the front end 26 of the loading floor carrier 18 and the rear portion 10 of the rear seat 8 in a transverse direction. The expansion 30 of the partial elongated section 24 in the longitudinal direction 23 of the motor vehicle 1 corresponds to roughly 20% of the expansion 28 of the loading floor carrier 28 in the longitudinal direction. The partial elongated section 24 of the cover 19 thus exhibits an expansion 30 in the longitudinal direction 23 that is large enough to completely cover the space or distance between the rear portion 10 of the rear seat 8 and the front end 26 of the loading floor carrier 18. To this end, a front end 32 of the partial elongated section 24 of the cover 19 rests completely on the rear portion 10 of the rear seat 8 in a transverse direction. The transverse direction of the motor vehicle 1 is aligned perpendicular to the longitudinal direction 23, i.e., the transverse direction is aligned perpendicular to the drawing plane on FIGS. 1 and 2.

The cover 19 is joined or fastened to the loading floor carrier 18 integrally, meaning with adhesive. The cover 19 is here not integrally joined with the upper side 30 of the loading floor carrier 18 on a partial region of the upper side 13 of the loading floor carrier 18 above the attachment 22 according to the view on FIG. 2, so that no integral connection between the cover 19 and upper side 13 of the loading floor carrier 18 is resultantly present at a front end region of the loading floor carrier 18. The integral connection is thus exclusively present only outside of the front end region of the upper side 13 of the loading floor carrier 18 between the cover 19 and loading floor carrier 18. For example, the front end region of the loading floor carrier 18 encompasses less than 5%, 10%, 20% or 30% of the expansion 28 of the loading floor carrier 18 in the longitudinal direction 23.

At this front end region of the loading floor carrier 18, the cover 19 can thus exhibit a vertical distance to the upper side 13 of the loading floor carrier 18 in the area of the attachment 22. Furthermore, the second part 35 of the sound insulation 33 is also fastened on the bottom side 14 of the loading floor carrier 18, and due to this partial formation of the integral connection between the cover 19 and loading floor carrier 18, the first part 34 of the sound insulation 33 is also located at an area above the attachment 22 between the cover 19 and upper side 13 of the loading floor carrier 18. The sound insulation 33, and hence the first part 34 of the sound insulation 33 as well, is flexible and bendable like the cover 19, so that the cover 19 together with the first part 34 of the sound insulation 33 can deform in a bendable and flexible manner at the area without the integral connection with the loading floor carrier 18, so as to adjust to varying geometries of devices between the front end 26 of the loading floor carrier 18 and the rear seat 8 (FIG. 2).

After fabricating the cover 19, for example via stamping out a prescribed geometry, the alignment of the cover 19 relative to the loading floor carrier 18 can be aligned accordingly by a corresponding relative adhesive bonding position of the cover 19 to the loading floor carrier 18, so that no gap is present between the rear end of the cover 19 and rear stop element 43 or interior lining 41.

Without any clearance or distance, the loading floor carrier 18 rests on the front stop element 36 with the front end 26, and on the rear stop element 43 with the rear end 27. This precludes any sliding by the loading floor carrier 18, and hence the luggage compartment 12, in the longitudinal direction 23 of the motor vehicle 1. When a front end of the first part 34 of the sound insulation 33 rests on the rear seat 8, the first part 34 of the sound insulation 33 can further rest and/or abut against the rear portion 10 of the rear seat 8 with an elastic preload in the longitudinal direction 23, so that the first part 34 of the sound insulation 33 thereby precludes any gap between the rear seat 8 and first part 34 of the sound insulation 33 due to the elastic characteristics of the sound insulation 33, even given assembly inaccuracies.

Viewed overall, significant advantages are associated with the motor vehicle 1 according to the present disclosure. The partial elongated section 24 of the cover 19 with the first part 34 of the sound insulation 33 covers a region between the front end 26 of the loading floor carrier 18 and a rear end of the rear seat 8. As a result, the lower border of the luggage compartment 11 is designed with the identical visual and haptic characteristics as the remaining bottom side border of the luggage compartment 11 in the region of or in proximity to the rear seat 8, since it includes the upper side of the luggage compartment floor 12, i.e., the cover 19. The visual and haptic characteristics can be improved as a result, in addition to which the first part 34 of the sound insulation 33 makes it possible to improve the sound insulation 33 on the luggage compartment 11. The stop element 36 also serves as a bracket for pivotably mounting the luggage compartment floor 12, and a transverse movement by the luggage compartment floor 12 is blocked due to the positive connection between the projections 38 and recesses 39, even in a lifted position of the luggage compartment floor 12 as denoted by the dashed lines on FIG. 2. As a result, the luggage compartment floor 12 is also especially comfortable and safe to handle in practice while removing objects inside of the spare tire well 17. The first part 34 of the sound insulation 33 can also extend as far as the rear seat 8, so that a front end of the first part 34 of the sound insulation 33 rests and/or abuts against the rear portion 10 of the rear seat 8, or is elongated until under the rear portion 10 of the rear seat 8. This makes it possible to further improve the sound insulation 33, and avoid a gap between the sound insulation 33 and rear seat 8.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-15. (canceled)

16. A motor vehicle comprising:
a body defining a passenger compartment and a luggage compartment for hold cargo separate from the passenger compartment;
a movable luggage compartment floor providing a lower border for the luggage compartment to support cargo in the luggage, the luggage compartment floor including a loading floor carrier, a cover on the loading floor carrier, and an attachment pivotably mounting and securing the luggage compartment floor at a front end region of the luggage compartment;
wherein the cover is formed on a partial elongated section before a front end of the loading floor carrier in the longitudinal direction of the motor vehicle.

17. The motor vehicle according to claim 16, wherein the cover is not connected to an upper side of the loading floor carrier above the attachment.

18. The motor vehicle according to claim 16, further comprising an expansion in a transverse direction of the partial elongated section of the cover corresponds to an expansion of the loading floor carrier at the front end region.

19. The motor vehicle according to claim 16, wherein an expansion of the partial elongated section of the cover in the longitudinal direction of the motor vehicle measures in a range of between 1% and 20% of a total expansion of the loading floor carrier in the longitudinal direction of the motor vehicle.

20. The motor vehicle according to claim 16, wherein a front end of the partial elongated section of the cover abuts a rear seat located in the passenger compartment.

21. The motor vehicle according to claim 16, wherein the cover is integrally joined to a partial region of the upper side of the loading floor carrier with an adhesive.

22. The motor vehicle according to claim 16, wherein the cover comprising a flexible region such that the partial elongated section of the cover is flexible.

23. The motor vehicle according to claim 16, further comprising a sound insulation fastened to a bottom side of the partial elongated section of the cover.

24. The motor vehicle according to claim 23, wherein the sound insulation comprising a flexible portion such that the partial elongated section of the cover is flexible.

25. The motor vehicle according to claim 16, wherein the attachment comprising a front stop element for limiting a forwardly directed movement by the luggage compartment floor in the longitudinal direction.

26. The motor vehicle according to claim 25, wherein the attachment further comprising a front support element located below the luggage compartment floor for supporting a front end region of the luggage compartment floor.

27. The motor vehicle according to claim 26, wherein the front stop element and a front end region of the loading floor carrier comprise a geometrically complementary structure such that forces in the transverse direction of the motor vehicle can be positively transferred from the loading floor carrier to the front stop element.

28. The motor vehicle according to one or several of claims 26, further comprising projections formed at the front end region of the loading floor carrier and positively engaging into recesses at the front stop element.

29. The motor vehicle according to claim 16, wherein the cover comprises a single piece.

30. The motor vehicle according to claim 16, wherein the cover is selected from the group consisting of a carpet, a fabric, a felt or a film.
